(19) United States
(12) Patent Application Publication
(10) Pub. No.: US 2014/0067561 A1
(43) Pub. Date: Mar. 6, 2014

(54) INFORMATION PROCESSING DEVICE AND PROGRAM

(71) Applicant: Toshiba Tec Kabushiki Kaisha, Tokyo (JP)

(72) Inventor: Masayoshi HARADA, Shizuoka-ken (JP)

(73) Assignee: Toshiba Tec Kabushiki Kaisha, Tokyo (JP)

(21) Appl. No.: 14/013,506

(22) Filed: Aug. 29, 2013

(30) Foreign Application Priority Data
Sep. 5, 2012 (JP) 2012-195410

(51) Int. Cl. G06Q 30/06; G06Q 50/12

(52) U.S. Cl. CPC G06Q 30/0641; G06Q 50/12
USPC 705/15

(57) ABSTRACT

An information processing device which allocates items to UI components included in an order receiving terminal, includes a first display unit configured to display a list of the items on a display device and a second display unit configured to display, on the display device, an allocation screen including component images corresponding to each UI component included in the order receiving terminal. The device further comprises an allocation unit configured to allocate a selected item from the list to one of the component images designated as the allocation destination of the item, a generation unit configured to generate allocation information including the selected item and the UI component corresponding to the component image to which the selected item is allocated, and a provision unit configured to provide the allocation information generated by the generation unit to the order receiving terminal.

### CROSS-REFERENCE TO RELATED APPLICATION

This application is based upon and claims the benefit of priority from Japanese Patent Application No. 2012-195410, filed Sep. 5, 2012, the entire contents of which are incorporated herein by reference.

### FIELD

Embodiments described herein relate generally to an information processing device and a program.

### BACKGROUND

In restaurants such as family restaurants or a pub, an order management system capable of integrally managing various functions from ordering from the food and drink menu to processing payment is introduced. Such a system is configured to receive an order of items from the menu with an order receiving terminal such as a handy terminal, and to manage order information showing the ordered content with an ordering management device.

In the order receiving terminal, various menu items are allocated in a user interfaces (UI), such as software buttons or physical keys. By operating this UI, the corresponding menu items are input. In the related art, in the order receiving terminal, a technology capable of performing allocation of menu items in the UI included in a host terminal is proposed.

However, in the technology of the related art, the allocating operation is performed in each order receiving terminal, which is inefficient.

### DESCRIPTION OF THE DRAWINGS

FIG. 1 illustrates a schematic configuration of an order management system according to an embodiment.

FIG. 2 illustrates an example of data stored in a product category database.

FIG. 3 illustrates an example of data stored in a product database.

FIG. 4 illustrates an example of data stored in a function category database.

FIG. 5 illustrates an example of data stored in a function database.

FIG. 6 illustrates an example configuration of a UI setting device.

FIG. 7 illustrates an example of a UI setting screen displayed by the UI setting device.

FIG. 8 illustrates another example of a UI setting screen displayed by the UI setting device.

FIG. 9 is a block diagram illustrating an example of a configuration of a first electronic menu terminal.

FIG. 10 illustrates an order input screen displayed by the first electronic menu terminal.

FIG. 11 is a block diagram illustrating an example of a configuration of a second electronic menu terminal.

FIG. 12 illustrates an example of an appearance configuration of the second electronic menu terminal.

FIG. 13 illustrates another example of an appearance configuration of the second electronic menu terminal.

FIG. 14 is a flowchart showing an example UI setting process.

FIG. 15 is a flowchart showing an example UI setting reflection process.

### DETAILED DESCRIPTION

An information processing device which allocates items to UI components included in an order receiving terminal, according to an embodiment, comprises a first display unit configured to display a list of the items on a display device and a second display unit configured to display, on the display device, an allocation screen including component images corresponding to each UI component included in the order receiving terminal. The device further comprises an allocation unit configured to allocate a selected item from the list to one of the component images designated as the allocation destination of the item, a generation unit configured to generate allocation information including the selected item and the UI component corresponding to the component image to which the selected item is allocated, and a provision unit configured to provide the allocation information generated by the generation unit to the order receiving terminal.

Hereinafter, embodiments of an information processing device and a program according to the embodiment will be described in detail with reference to the accompanied drawings.

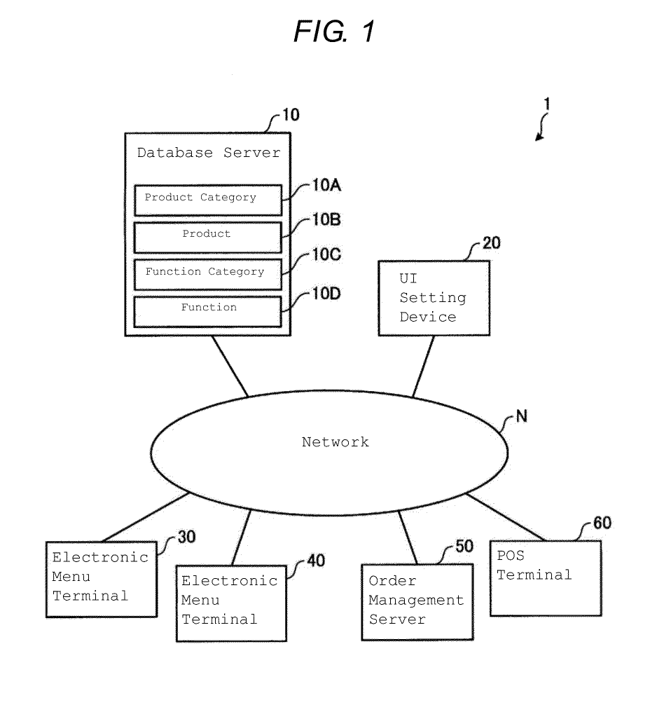

FIG. 1 illustrates a schematic configuration of an order management system 1 according to the embodiment. As shown in FIG. 1, the order management system 1 includes a database server 10, a UI setting device 20, a first electronic menu terminal 30, a second electronic menu terminal 40, an order management server 50, and a POS terminal 60. The components are in data communication through a network N such as a Local Area Network (LAN). In addition, the number of the first electronic menu terminals 30 and the second electronic menu terminals 40 connected to the network N is not particularly set.

The database server 10 is a server device which stores and manages data related to various operations. The data includes are allocation targets for UI components included in the first electronic menu terminal 30 and the second electronic menu terminal 40. The UI components may be software buttons (GUI) on an UI of the first electronic menu terminal 30 and the second electronic menu terminal 40. The UI components may also be hardware keys.

In more detail, the database server 10 stores and manages a product category database (DB) 10A, a product DB 10B, a function category DB 10C, and a function DB 10D.

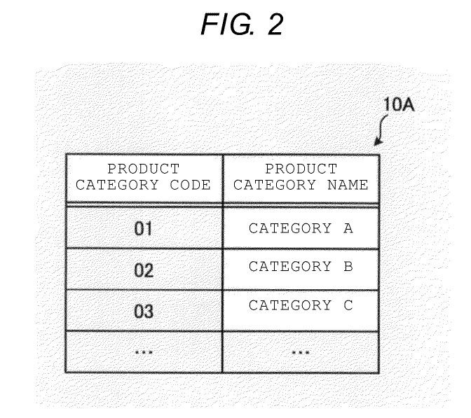

The product category DB 10A stores information according to the categories for classifying various products. An example of data stored in the product category DB 10A is shown in FIG. 2. As shown in FIG. 2, a record stored in the product category DB 10A includes a product category code and a product category name. The product category name is the name of categories such as drinks, deserts, appetizer, and the like. The product category code is unique identification information allocated to each product category.

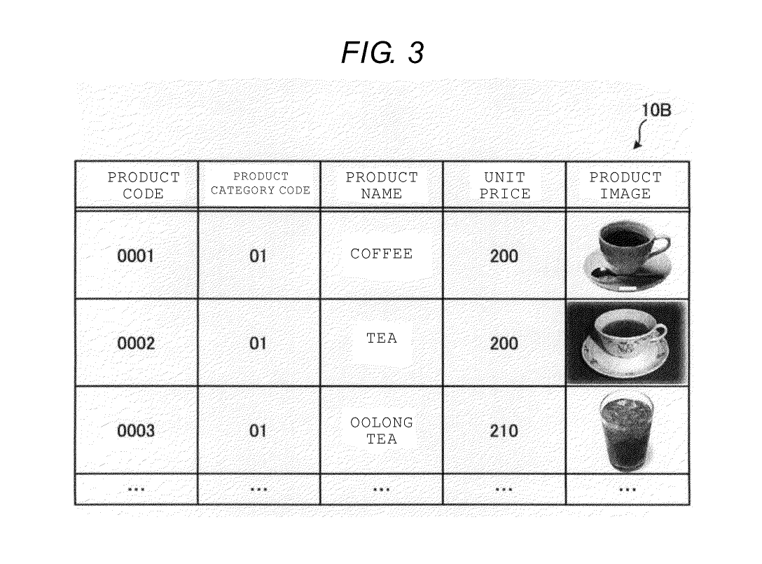

The product DB 10B stores product information for each product. An example of data stored in the product DB 10B is shown in FIG. 3. As shown in FIG. 3, the record of the product DB 10B includes a product code, a product category code, a product name, unit price, a product image, and the like. Each record of the product DB 10B functions as an item (product item) which is an allocation target in the UI setting device 20.

The product code is a unique code allocated for each product and is used for identifying each product. The product category code is a code of the product category where the product belongs. The product name and the unit price are a name of the product and price for one product, respectively. In addition, the product image is image data shows the product or a link for reading out the image data. The image data may be stored in the database server 10. However, it is not limited thereto, and the image data may also be stored in an external device which the database server 10 can access.

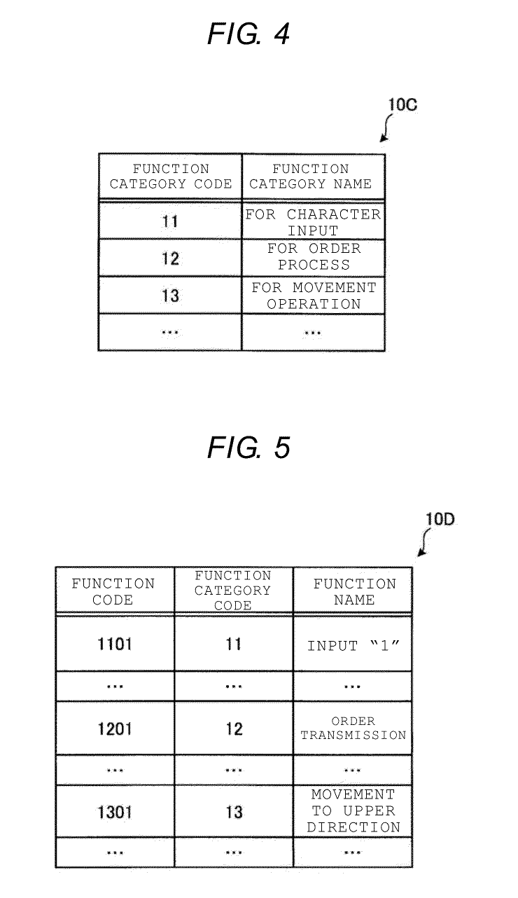

The function category DB 10C stores information related to classifying various functions realized in the first electronic menu terminal 30 and the second electronic menu terminal 40 (which will be described later). An example of data stored in the function category DB 10C is shown in FIG. 4. As shown in FIG. 4, a record stored in the function category DB 10C includes a function category code and a function category name. For example, the function category name is a name of functions related to an input of characters such as numerical values. The function category names include character input, order processes related to an order process of products, or movement operations related to a movement function to left, right, up, and down directions. The function category code is code allocated to each functional category for identifying each function category.

The function DB 10D stores function information related to order of function, for each function. An example of data stored in the function DB 10D is shown in FIG. 5. As shown in FIG. 5, a record of the function DB 10D includes a function code, a function category code, a function name, and the like. Each record of the function DB 10D is an item (function item) that can be an allocation target in the UI setting device 20.

The function code is a unique code allocated for each function for identifying each function. The function category code indicates the function category to which the function belongs. The function name is a name of the function.

Returning to FIG. 1, the UI setting device 20 is an information processing device which sets the UI used in the first electronic menu terminal 30 and the second electronic menu terminal 40.

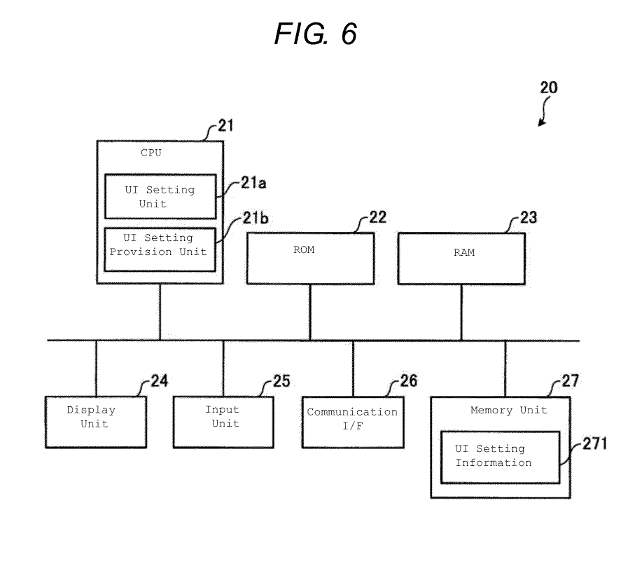

FIG. 6 is a block diagram of the UI setting device 20. As shown in FIG. 6, the UI setting device 20 includes a Central Processing Unit (CPU) 21, a Read Only Memory (ROM) 22, and a Random Access Memory (RAM) 23. The UI setting device may be a microcomputer which executes information processing.

The CPU 21 collectively controls operations of the UI setting device 20, by executing various programs stored in the ROM 22 or a memory unit 27 which will be described later. The ROM 22 stores the programs for performing basic operations. The RAM 23 is a main memory device of the UI setting device 20, and functions as a work area of the CPU 21.

In addition, a display unit 24 and an input unit 25 are connected to the CPU 21, through various input and output circuits (not shown). The display unit 24 includes a display device such as a liquid crystal display panel, and displays various information items according to designation of the CPU 21. The input unit 25 is an input device such as a keyboard or a pointing device, and communicates input from an operator to the CPU 21.

A communication I/F 26 and the memory unit 27 are connected to the CPU 21 through various input and output circuits (not shown). The communication I/F 26 is an interface for performing data communication with an external device (not shown). The CPU 21 controls this communication I/F 26 to perform transmission and reception of various data items to and from an external device according to a predetermined communication protocol.

The memory unit 27 is a memory medium such as a Hard Disk Drive (HDD) or a flash memory, and stores various programs or setting information. In addition, the memory unit 27 stores UI setting information 271 generated by a UI setting unit 21a which will be described later.

Next, a functional configuration of the UI setting device 20 will be described. As shown in FIG. 6, the CPU 21 includes the UI setting unit 21a and a UI setting provision unit 21b as a functional unit in cooperation with programs stored in the ROM 22 or the memory unit 27.

The UI setting unit 21a displays a screen (UI setting screen) for allocating items to UI components of various electronic menu terminals such as the first electronic menu terminal 30 and the second electronic menu terminal 40, on the display unit 24.

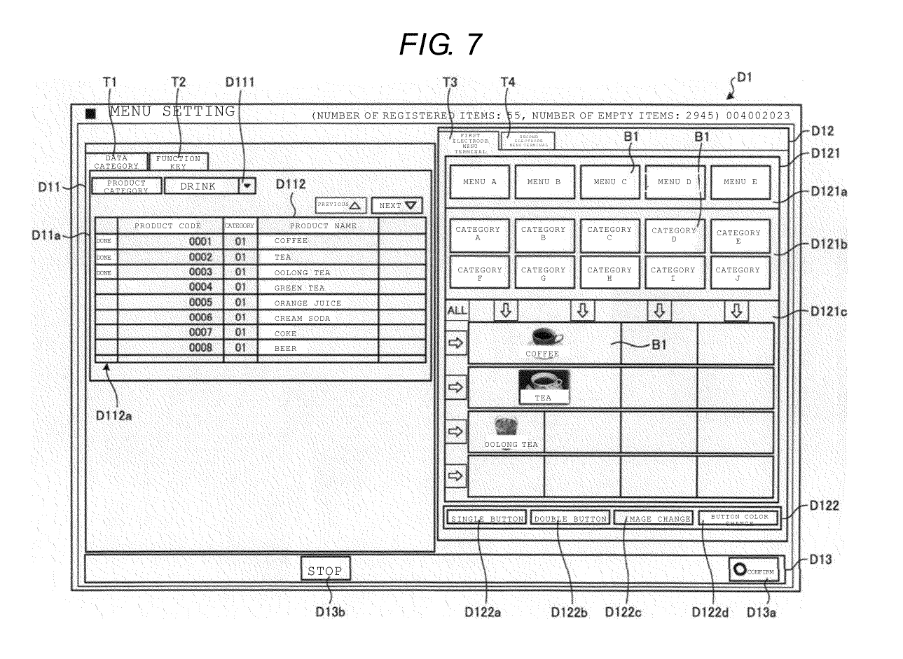

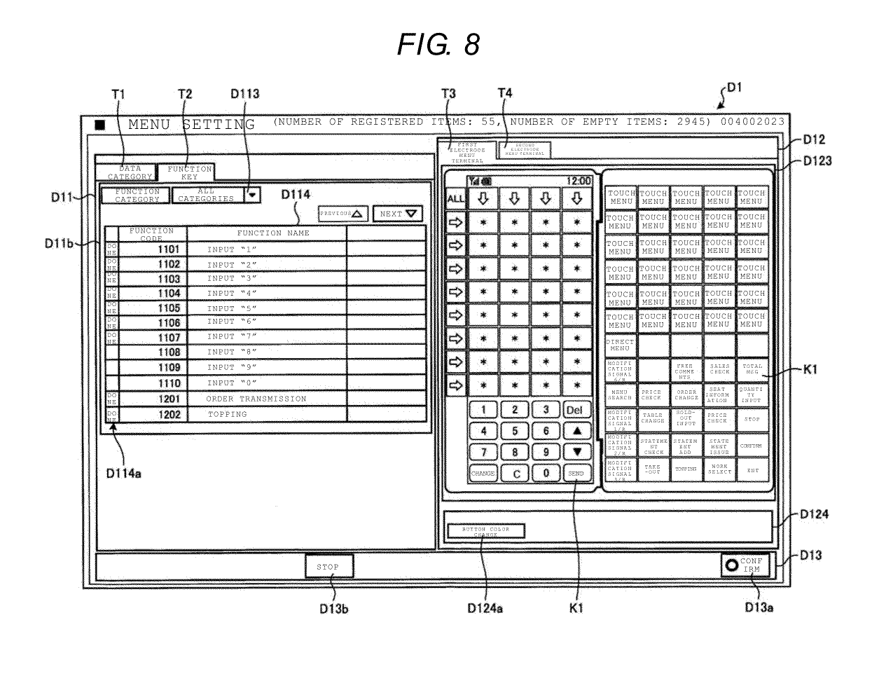

FIGS. 7 and 8 are views showing examples of a UI setting screen. As shown in FIGS. 7 and 8, a UI setting screen D1 displays an item selection screen D11 for displaying items stored and managed in the database server 10, an allocation screen D12 showing the UI of various electronic menu terminals such as the first electronic menu terminal 30 and the second electronic menu terminal 40, and an operation button region D13 where the various operation buttons are provided.

In the item selection screen D11, a product item selection screen D11a for product item selection and a function item selection screen D11b for function item selection can be switched between by tabs T1 and T2. Herein, FIG. 7 shows the product item selection screen D11a displayed by selection of the tab T1, and FIG. 8 shows the function item selection screen D11b displayed by selection of the tab T2.

On the product item selection screen D11a shown in FIG. 7, a product category selection column D111, an item display column D112, and the like are displayed. The product category selection column D111 is configured to allow selection of a product category which is a target of reading-out, among product categories registered in a product category DB 10A of the database server 10, by a pull-down or pop-up format. In addition, FIG. 7 shows an example in which a product category “drink” is selected.

On the item display column D112, among product items registered in the product DB 10B of the database server 10, product items which belong to the product category selected by the product category selection column D111 are displayed as a list. In addition, in the item display column D112, an add column D112a for adding additional information showing the effect (“done” in the drawing) is provided with respect to the allocated product items.

A function category selection column D113, a function display column D114, and the like are displayed in the function item selection screen D11b shown in FIG. 8. The function category selection column D113 is configured to be allow a selection of a function category which is a target of reading-out, among function categories registered in a function category DB 10C of the database server 10, by a pull-down or pop-up format. In addition, FIG. 8 shows an example in which “all categories” which designates all function categories is selected.

On the function display column D114, among function items registered in the function DB 10D of the database server 10, function items which belong to the function category selected by the function category selection column D113 are displayed as a list. In addition, in the function display column D114, an add column D114a for adding additional information showing the effect (“done” in the drawing) is provided with respect to the allocated function items.

In the allocation screen D12, an allocation screen for the first electronic menu terminal 30 and an allocation screen for the second electronic menu terminal 40 can be switched between by tabs T3 and T4. FIG. 7 shows an allocation screen for the first electronic menu terminal 30 displayed by the selection of the tab T3, and FIG. 8 shows an allocation screen for the second electronic menu terminal 40 displayed by the selection of the tab T4.

A menu button display column D121 and a setting button region D122 are displayed on the allocation screen for the first electronic menu terminal 30 shown in FIG. 7.

The menu button display column D121 is divided into three regions (panes): a first region D121a, a second region D121b, and a third region D121c. A “single button” or a “double button” (hereinafter, collectively called a menu button B1) can be disposed in the first region D121a to the third region D121c, as component images corresponding to the UI components of the first electronic menu terminal 30. In addition, an arbitrary name can be given to the menu button B1.

The second region D121b is configured to switch display for each menu button B1 disposed in the first region D121a. If one menu button B1 is selected from the first region D121a, one or a plurality of menu buttons B1 correlated to the menu button B1 are displayed in the second region D121b.

The third region D121c is configured to switch display for each menu button B1 disposed in the second region D121b. If one menu button B1 is selected from the second region D121b, one or a plurality of menu buttons B1 correlated to the menu button B1 are displayed in the third region D121c.

As described above, the relationship of the first region D121a, the second region D121b, and the third region D121c corresponds to a hierarchical relationship, e.g. arranged according to a major item, a mid-range item, and a minor item. The menu button B1 displayed in each region is an allocation destination of the item. In the embodiment, with respect to the menu button B1 displayed in the third region D121c, a format of performing allocation of a product item is supposed. However, the configuration of the allocation screen or the item of the allocation target are not limited thereto.

The setting button region D122 includes: a first setting button D122a for designating the menu button B1 as having a predetermined “single button” size; a second setting button D122b for designating the menu button B1 as having a “double button” size, which is a double size of the single button; a third setting button D122c for designating (changing) images displayed on the menu button B1; a fourth setting button D122d for designating (changing) colors of the menu button B1 Other buttons for related functions of defining the menu button B1 may be displayed on the setting button region D122. The UI setting unit 21a disposes the menu buttons B1 in the first region D121a, the second region D121b, and the third region D121c, according to the designation of the setting buttons through the input unit 25.

When the first setting button D122a is held down, the UI setting unit 21a disposes the “single button” in a region in the allocation screen D12 designated as an installation target. In addition, when the second setting button D122b is held down, the UI setting unit 21a disposes the “double button” in a region in the allocation screen D12 designated as an installation target. Further, the disposition location of the menu button B1 in each region can be arbitrarily adjusted by the operations (for example, dragging and dropping) through the input unit 25.

When the third setting button D122c is held down, the UI setting unit 21a displays a separately designated image on the menu button B1 which is a changing target. In general, a product image of an allocated item (product) is displayed on the menu button B1. In addition, when the fourth setting button D122d is held down, the UI setting unit 21a displays a color selection screen for an operator to select colors from a color palette or the like and changes the color of the menu button B1 which is a changing target to the selected color.

A key arrangement display column D123 and a setting button region D124 are displayed on an allocation screen for the second electronic menu terminal 40 shown in FIG. 8.

A key arrangement image showing the UI of the second electronic menu terminal 40 (see FIG. 13) is displayed on the key arrangement display column D123. The component image corresponding to each key—which is the UI component included in the second electronic menu terminal 40—is contained in the key arrangement image as a key image K1. In addition, an arbitrary name can be given to the key image K1.

A fifth setting button D124a for designating (changing) colors of the key image displayed on the key arrangement display column D123 is displayed on the setting button region D124. When the fifth setting button D124a is held down, the UI setting unit 21a displays the color selection screen for an operator to select the colors from the color palette, and changes the color of the key image to the selected color.

When the allocation of the item is performed using the allocation screen D12 described above, an operator of the UI setting device 20 performs operations which will be described later. First, from items to be displayed on the item selection screen D11 as a list, items to be targets of allocation are selected. Then, the selected items are dragged and dropped in the component image (menu button B1 or key image K1) which is the allocation destination disposed in the menu button display column D121 or the key arrangement display column D123.

For example, in a case of performing allocation of the product item a product item (for example, coffee) to be an allocation target is selected from the list of the item display column D112 shown in FIG. 7. The selected product item is dragged and dropped in any menu button B1 displayed in the third region D121c. In addition, from the list of the function display column D114 shown in FIG. 8, a function item (for example, order send) to be an allocation target is selected, and dragged and dropped in any key image K1 displayed in the key arrangement display column D123.

The UI setting unit 21a allocates a record of the item which has been set to be a target of allocation to the component image which is the allocation destination, according to the operation described above. In addition, the UI setting unit 21a adds “done” marks showing completion of allocation to the add column D114a of the allocated item (see FIG. 8) as additional information. Accordingly, discrimination of the allocated items is improved, and thus it is possible to improve convenience when performing allocation.

A confirmation button D13a for designating confirmation of allocation, a stop button D13b for designating stop of allocation, and the like are displayed on the operation button region D13 shown in FIGS. 7 and 8. When the confirmation button D13a is held down, for each electronic menu terminal which is a target of setting, the UI setting unit 21a generates allocation information obtained by connecting the item subject to the allocation for the electronic menu terminal and the UI component corresponding to the component image to which the item is allocated. In addition, the UI setting unit 21a stores the UI setting information at least containing the generated allocation information in the memory unit 27 by connecting with device identification information which can identify the electronic menu terminal which has been set to be the allocation destination.

In the embodiment described herein, all records of the allocated items are set to be contained in the allocation information. However, it is not particularly limited thereto, and information of a part of records may be contained. For example, as a part of the record, a product code or a function code which can identify the item may be contained in the UI setting information. In addition, layout information which designates a layout (containing disposition state, color, and name) of the menu button B1 in the allocation screen or a layout of the key image K1 may be contained in the UI setting information.

When the stop button D13b of the operation button region D13 is held down, the UI setting unit 21a closes the UI setting screen without generating UI setting information. Further, when restarting the UI setting screen, if the UI setting information exists in the memory unit 27, the UI setting unit 21a may display the allocation screen obtained by reflecting the UI setting information. In this case, among items displayed on the product item selection screen Dlla and the function item selection screen D11b, the item included in the UI setting information is set to be displayed in a state where the “done” mark showing allocation completion is added.

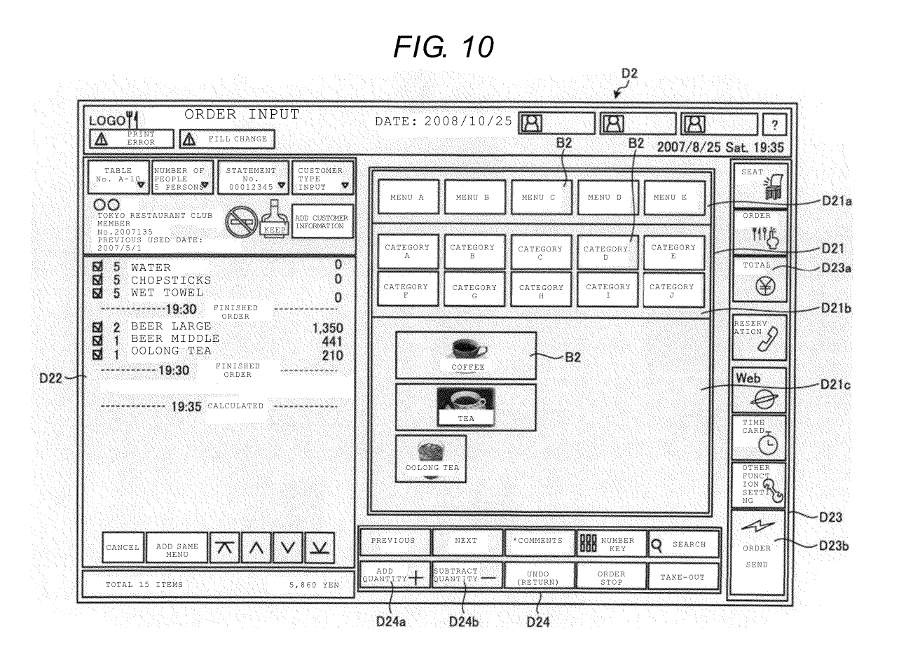

In FIG. 7, in a graphical user interface (GUI) of the first electronic menu terminal 30 which will be described later, when allocation of the item is set to be performed in a portion of the menu button display column D121, the allocation can also be performed in other GUI portions in the same manner (for example, a work designation button region D23 and an operation button region D24 which will be described later (see FIG. 10)).

As described above, the UI setting device 20 of the embodiment displays the allocation screen according to the UI of each electronic menu terminal. If the item is allocated to the component image included in the allocation screen, the UI setting device generates allocation information obtained by connecting the item to the UI component of each electronic menu terminal corresponding to the component image. Accordingly, an operator of the UI setting device 20 can perform allocation of the item while checking the UI (UI component) of the first electronic menu terminal 30 and the second electronic menu terminal 40. Thus, the operation performance is improved for the operator and the allocation operation can be efficiently performed.

As shown in FIG. 6, the UI setting provision unit 21b is a functional unit which provides UI setting information generated by the UI setting unit 21a to the electronic menu terminals which are the allocation destination, using the communication I/F 26. Herein, a providing method of the UI setting information is not particularly limited. The method may be a method of a push type of transmitting the information from the UI setting device 20 to each electronic menu terminal, or may be a method using a pull type of transmitting UI setting information according to acquisition requirements from the electronic menu terminal.

In the embodiment, the UI setting information is set to be provided to the corresponding electronic menu terminal each time when the UI setting information is generated by the UI setting unit 21a. If new UI setting information is generated by the UI setting unit 21a, the UI setting provision unit 21b notifies the electronic menu terminal destination (shown by the device identification information related to the UI setting information) of the update information designating updating of the UI setting information. In addition, if the acquisition requirements of the UI setting information are received from the electronic menu terminal as a response to the update information, the UI setting provision unit 21b provides (e.g., transmits) the UI setting information to this electronic menu terminal destination.

As described above, in the UI setting device 20 of the embodiment, if the allocation information is generated (updated), since the UI setting information including the allocation information is provided to the corresponding electronic menu terminal, the allocation content of a new item can be reflected in each electronic menu terminal. In addition, even when a plurality of electronic menu terminals having different UI exist, because the allocation of items is performed in one UI setting device 20 and therefore can be reflected in each electronic menu terminal, complicated operations for performing allocation in each electronic menu terminal can be decreased and efficiency of the allocation operations can be increased.

Next, the first electronic menu terminal 30 will be described. The first electronic menu terminal 30 is an order receiving terminal such as a tablet terminal including the GUI operated by a store staff or the like. The first electronic menu terminal 30 performs functions of displaying a list of a plurality of food and drink menu products offered to customers in a restaurant and transmitting products ordered by the customers from menu products to the order management server 50.

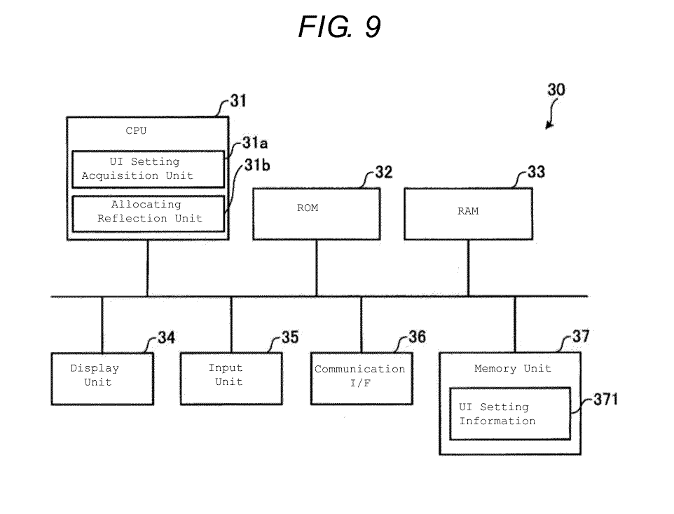

FIG. 9 is a block diagram showing an example of a configuration of the first electronic menu terminal 30. As shown in FIG. 9, the first electronic menu terminal 30 includes a CPU 31, a ROM 32, and a RAM 33, as a microcomputer executing information processing.

By executing various programs stored in the ROM 32 or a memory unit 37 which will be described later, the CPU 31 collectively controls the first electronic menu terminal 30. The ROM 32 stores programs for performing basic operations. The RAM 33 is a main memory device of the first electronic menu terminal 30, and functions as a work area of the CPU 31.

In addition, a display unit 34 and an input unit 35 are connected to the CPU 31, through various input and output circuits (not shown). The display unit 34 includes a display device such as a liquid crystal display panel, and displays various information items according to designation of the CPU 31. The input unit 35 is an input device such as a touch panel or the like provided on the display surface of the display unit 34, and communicates input from an operator to the CPU 31.

In addition, a communication I/F 36 and the memory unit 37 are connected to the CPU 31, through various input and output circuits (not shown). The communication I/F 36 is an interface for performing data communication with an external device. The CPU 31 controls this communication I/F 36 to perform transmission and reception of various data items to and from an external device according to a predetermined communication protocol. The memory unit 37 is a memory medium such as a HDD or a flash memory, and stores various programs or setting information. In addition, the memory unit 37 stores UI setting information 371 for the host terminal.

In the configuration described above, the CPU 31 displays an order input screen as shown in FIG. 10 on the display unit 34, as a GUI for receiving order of the products, based on allocation information or layout information included in UI setting information 371 stored in the memory unit 37, which will be described later.

FIG. 10 is an example of the order input screen. A menu selection screen D21 (a first region D21a, a second region D21b, a third region D21c) corresponding to the menu button display column D121 (see FIG. 7) are set in the UI setting device 20. The order input screen also includes an order list region D22, a work designation button region D23, an operation button region D24, and the like.

A menu button B2 corresponding to the menu button B1 described above is displayed on the menu selection screen D21 as an UI component for which touch designation may be performed by the touch panel. As will be described later, an operator of the first electronic menu terminal 30 can designate the specified product items through the menu buttons B2 displayed on the first region D21a, the second region D21b, and the third region D21c.

When the function items are allocated to the designated menu button B2, the function is set to be executed by the CPU 31. The programs for realizing such functions are stored in the memory unit 37 in advance.

The product name, number of orders, price (unit price×number of orders) which are designated by touching on the menu selection screen D21 are displayed on the order list region D22 as a list. In addition, the unit price of the product may be read out from the record of the corresponding product included in the UI setting information. Alternatively, the unit price of the product corresponding to the product code may be inquired to the database server 10, based on the product code included in the UI setting information.

Buttons for designating execution of various functions—such as a total button D23a related to execution of a totaling process and an order send button D23b related to execution of order transmission—are displayed on the work designation button region D23 as the UI components which can be designated by touching using a touch panel.

Similarly, buttons for designating execution of various functions—such as an add quantity button D24a related to execution of a process for adding a number of orders and a subtract quantity button D24b related to execution of a process for subtracting a number of orders—are displayed on the operation button region D24, as the UI components which can be designated by touching using a touch panel.

In such a UI, when inputting products, a desired menu button B2 can be selected from the menu buttons B2 which are “menu A”, “menu B”, “menu C”, “menu D”, and “menu E” displayed on the first region D21a by touch designation. For example, when the “menu A” is designated by touching, the menu button B2 of the “menu A” as shown in FIG. 10 as an example, is displayed on the second region D21b.

In addition, a desired menu button B2 can be selected from the menu buttons B2 which are “category A” to “category J” displayed on the second region D21b by touch designation. For example, when the “category A” is designated by touching, the menu button B2 of the “category A” (as shown in FIG. 10 as an example) is displayed on the third region D21c.

In addition, a desired menu button B2 can be selected by touch designation from the menu buttons B2 which are “coffee”, “tea”, and “oolong tea” displayed on the third region D21c. For example, when the “oolong tea” is designated by touching, the “oolong tea” is designated as an order target.

Next, the second electronic menu terminal 40 will be described. The second electronic menu terminal 40 is an order receiving terminal such as a hand terminal. In the same manner as the first electronic menu terminal 30, the second electronic menu terminal 40 has a function of displaying a list of a plurality of food and drink menu products offered to customers in a restaurant and transmitting products ordered by the customers from menu products to the order management server 50.

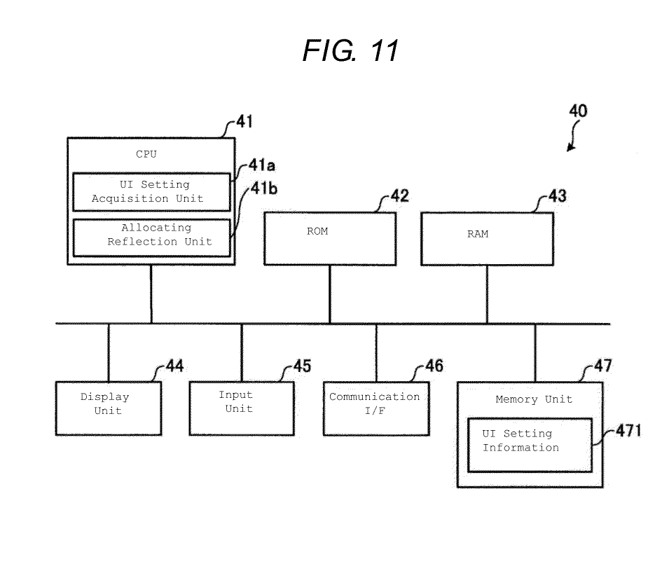

FIG. 11 is a block diagram showing a configuration of the second electronic menu terminal 40. As shown in FIG. 11, the second electronic menu terminal 40 includes a CPU 41, a ROM 42, and a RAM 43, as a microcomputer executing information processing.

By executing various programs stored in the ROM 42 or a memory unit 47 which will be described later, the CPU 41 controls the operations of the second electronic menu terminal 40. The ROM 42 stores programs for performing basic operations. The RAM 43 is a main memory device of the second electronic menu terminal 40, and functions as a work area of the CPU 41.

In addition, a display unit 44 and an input unit 45 are connected to the CPU 41, through various input and output circuits (not shown). The display unit 44 includes a display device such as a liquid crystal display panel, and displays various information items according to designation of the CPU 41. The input unit 45 is an input device, such as a first key sheet 413 and a second key sheet 421 which will be described later (see FIG. 13), and communicates input from an operator to the CPU 41.

In addition, a communication I/F 46 and the memory unit 47 are connected to the CPU 41, through various input and output circuits (not shown). The communication I/F 46 is an interface for performing data communication with an external device. The CPU 41 controls this communication I/F 46 to perform transmission and reception of various data items to and from an external device according to a predetermined communication protocol. The memory unit 47 is a memory medium such as a HDD or a flash memory, and stores various programs or setting information such as UI setting information 471. In addition, the memory unit 47 stores the UI setting information 471 for the host terminal.

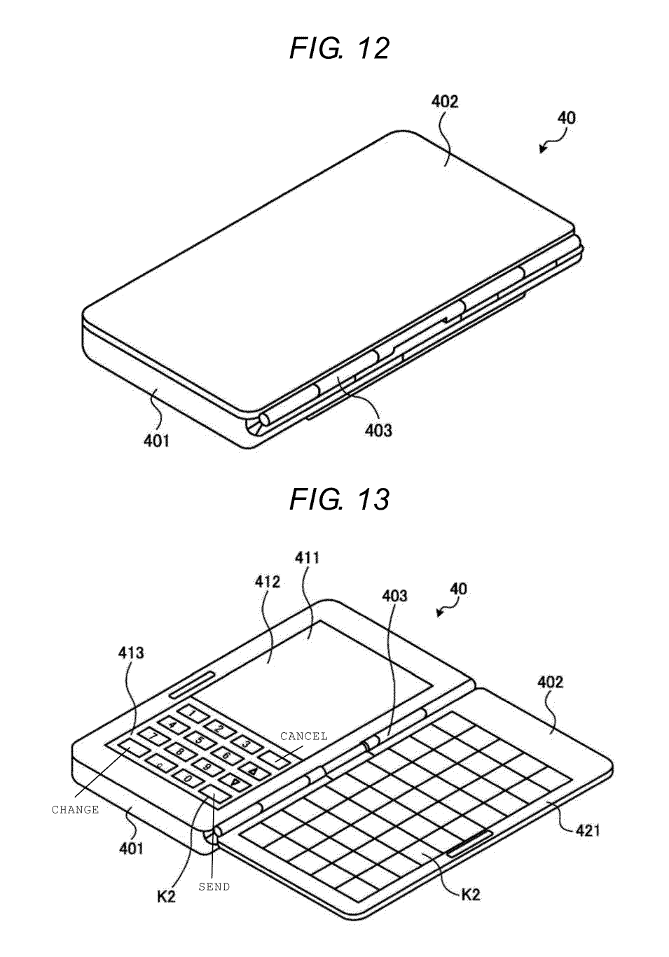

FIG. 12 is a perspective view showing an example of the second electronic menu terminal 40, in a state where the second electronic menu terminal 40 is closed (closed state). As shown in FIG. 12, the second electronic menu terminal 40 includes a first unit 401 and a second unit 402. The first unit 401 and the second unit 402 are connected to each other to be rotatably opened and closed by a hinge 403.

FIG. 13 is a perspective view of the second electronic menu terminal 40, in a state where the second electronic menu terminal 40 is opened (opened state). The first unit 401 includes an operation surface 411 on a surface closed by the second unit 402. A liquid crystal display panel 412 is provided on the operation surface 411. A first key sheet 413 is provided on a portion of the liquid crystal display panel 412 on a lower side. In addition, a second key sheet 421 is provided on the second unit 402.

Each key K2 on the first key sheet 413 and the second key sheet 421 is a UI component corresponding to the key image K1 in the key arrangement display column D123 shown in FIG. 8. The product to be the target of order or the function which is order confirmation is allocated to each key K2, based on the UI setting information stored in the memory unit 47.

If the key operation which designates a specified product from the first key sheet 413 or the second key sheet 421 is received, the CPU 41 displays the product name or the like of the product corresponding to the key K2 on the display unit 44. In addition, if the key operation which designates a specified function (for example, totaling or order sending) from the first key sheet 413 or the second key sheet 421 is received, the CPU 41 executes the function corresponding to the key K2. Labels showing product names or function names allocated to the key K2 are preferably added onto each key K2.

In such a UI, when inputting the product, the key K2 to which a desired product is allocated can be selected by a holding-down operation, among the keys K2 configuring the first key sheet 413 and the second key sheet 421. For example, when the “coffee” is selected, the “coffee” is designated as a product of an order target. Also, a specified function (for example, sending of the order) can be performed by performing the holding-down operation of the key K2 to which a desired function (for example, order send) is allocated.

Next, a functional configuration of the UI setting information for the first electronic menu terminal 30 and the second electronic menu terminal 40 will be described.

As shown in FIG. 9, the CPU 31 of the first electronic menu terminal 30 realizes a UI setting acquisition unit 31a and an allocation reflection unit 31b as functional units, by cooperation with the programs stored in the ROM. 32 or the memory unit 37. In addition, as shown in FIG. 11, the CPU 41 of the second electronic menu terminal 40 realizes a UI setting acquisition unit 41a and an allocation reflection unit 41b as functional units, by cooperation with the programs stored in the ROM 42 or the memory unit 47. Since the functional units of the first electronic menu terminal 30 and the second electronic menu terminal 40 are similar in such respects, the functional units of the first electronic menu terminal 30 will be described as an example, hereinafter, and the same description is similarly applicable to the second electronic menu terminal 40.

The UI setting acquisition unit 31a acquires UI setting information for the host terminal from the UI setting device 20 using the communication I/F 36, and stores the UI setting information in the memory unit 37 as the UI setting information 371.

However, an acquiring method of the UI setting information is not particularly limited. The method may be a method of acquiring the UI setting information for the host terminal of the push type of being transmitted from the UI setting device 20, or may be a method of acquiring the UI setting information provided by transmitting the acquisition requirements to the first electronic menu terminal 30. In the embodiment, the UI setting acquisition unit 31a transmits the acquisition requirements for requiring acquisition of the UI setting information to the UI setting device 20, according to the update information notified from the UI setting device 20.

The allocation reflection unit 31b allocates items corresponding to the UI components included in the host terminal, based on the allocation information or the layout information included in the UI setting acquisition unit 31a stored in the memory unit 37. Accordingly, the content allocated to the component image set in the UI setting device 20 is reflected in the UI components corresponding to the first electronic menu terminal 30.

Returning to FIG. 1, the order management server 50 is an information processing device specialized for managing order information of customers. The order management server 50 performs a register process of the order information received from each of the first electronic menu terminal 30 and the second electronic menu terminal 40. The POS terminal 60 calculates payment from the order information of the customer who asks for a bill, and issues a receipt after processing payment data with respect to the payment. Information items related to the product code or the number of orders of the product which is the order target or total such as total price are included in the order information.

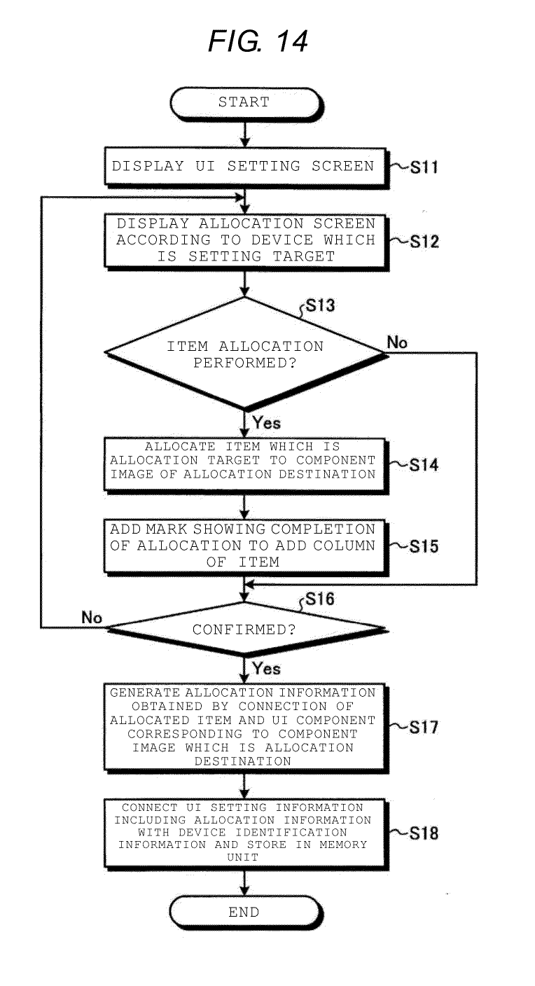

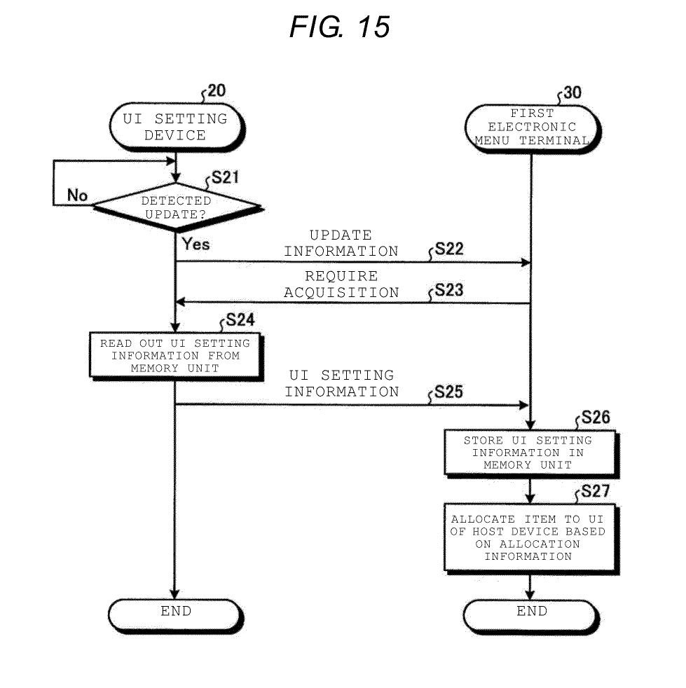

Hereinafter, the operation of the order management system 1 will be described with reference to FIGS. 14 and 15.

First, the UI setting process executed by the CPU 21 (UI setting unit 21a) of the UI setting device 20 will be described with reference to FIG. 14, which is a flowchart showing an example of the UI setting process.

If the display of the UI setting screen is designated through the input unit 25 or the like, the UI setting unit 21a displays the UI setting screen as shown in FIG. 7 or FIG. 8 on the display unit 24 (Step S11). In addition, the UI setting unit 21a displays the allocation screen D12 for the electronic menu terminal which is the allocation destination, designated by the selection of the tab T3 or T4 (Step S12).

Next, the UI setting unit 21a determines whether or not the allocation of the items displayed on the item display column D112 or the function display column D114 is performed by an operator of the UI setting device 20 (Step S13). Herein, when it is determined that the allocation is not performed (Step S13; No), the process proceeds to Step S16.

In Step S13, when it is determined that the allocation of the items is performed (Step S13; Yes), the UI setting unit 21a connects the item which is the allocation target to the component image which is the allocation destination (Step S14), and adds marks (additional information) showing the completion of the allocation to the add column of the item (Step S15).

In the subsequent Step S16, the UI setting unit 21a determines whether or not the confirmation button D13a is operated (Step S16). When it is determined that the confirmation button D13a is not operated (Step S16; No), the UI setting unit 21a returns to Step S12 and continues Steps S13 to S16.

When it is determined that the confirmation button D13a is operated (Step S16; Yes), the UI setting unit 21a generates allocation information obtained by connecting the allocated items with the UI components corresponding to the component images which are the allocation destination of the items, for each electronic menu terminal which is set to be the allocation destination (Step S17). Then, the UI setting unit 21a connects the UI setting information including the allocation information generated in Step S17 with the device identification information of the electronic menu terminal which is the allocation destination, and stores the information in the memory unit 27 (Step S18).

By the UI setting process described above, the allocation information obtained by connecting the items to the UI components included in the electronic menu terminal is generated, and the UI setting information including the allocation information is connected to the device identification information to be held in the memory unit 27.

Next, the UI setting reflection process executed between the UI setting device 20, and the first electronic menu terminal 30 and the second electronic menu terminal 40 will be described, with reference to FIG. 15. Herein, FIG. 15 is a flowchart showing the UI setting reflection process. In the process, an example where the electronic menu terminal which is the updating target of the UI setting information is set to the first electronic menu terminal 30 will be described, and the process of the second electronic menu terminal 40 is also set to be executed with the same procedure.

First, the UI setting provision unit 21b of the UI setting device 20 waits until the UI setting information 271 stored in the memory unit 27 is updated (Step S21; No). If the updating is detected (Step S21; Yes), the update information is notified to the electronic menu terminal (first electronic menu terminal 30) corresponding to the device identification information related to the UI setting information 271 (Step S22).

On the other hand, in the first electronic menu terminal 30, if the update information is received from the UI setting device 20, the UI setting acquisition unit 31a transmits the acquisition requirements to the UI setting device 20 (Step S23). By displaying that the update information is received on the display unit 34, the configuration may be that the update of the UI setting information is notified to an operator of the first electronic menu terminal 30, or may be that the acquisition requirements are transmitted according to the designation from an operator.

If the acquisition requirements are received from the first electronic menu terminal 30, the UI setting provision unit 21b of the UI setting device 20 reads out the UI setting information 271 related to the device identification information of the first electronic menu terminal 30 from the memory unit 27 (Step S24) and provides (e.g., transmits) the information to the first electronic menu terminal 30 (Step S25).

If the UI setting information 271 provided from the UI setting device 20 is acquired, the UI setting acquisition unit 31a of the first electronic menu terminal 30 stores acquired UI setting information 271 as the UI setting information 371 for the host terminal in the memory unit 37 (Step S26). Then, the allocation reflection unit 31b allocates corresponding items to the menu buttons provided as the UI components of the host terminal, based on the allocation information (layout information) included in the UI setting information 371 (Step S27).

As described above, according to the embodiment, since the allocation of the items to the UI components included in each electronic menu terminal is collectively performed in the UI setting device 20, and the allocation content can be reflected in each electronic menu terminal, the allocation operation can be efficiently performed.

While certain embodiments have been described, these embodiments have been presented byway of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiments described above, the database server 10 includes the product category DB 10A, the product DB 10B, the function category DB 10C, and the function DB 10D, however, it is not limited thereto, and the UI setting device 20 may include those.

In the embodiments described above, the items which are set to be the target of the allocation are set to products and functions, however, it is not limited thereto, and other items may be allocated.

In the embodiments described above, the electronic menu terminals having different UI generate the UI setting information, respectively, however, it is not limited thereto, and even in the terminals having the same UI, for example, the UI setting information may be generated for each terminal. In addition, even the UI of another device such as POS terminal 60 can be set in the same manner.

In the embodiments described above, an example including the UI setting device 20 as a separate device is described, however, it is not limited thereto, and the UI of the host terminal and other terminals may be set in each electronic menu terminal, by including the functional units of the UI setting device 20 in the first electronic menu terminal 30 and the second electronic menu terminal 40.

In addition, the program executed in each device of the embodiments described above is provided by being embedded in the recording medium (ROM or memory unit) included in each device in advance, however, it is not limited thereto, and the program may be configured to be provided by being stored in any suitable computer-readable memory media such as a CD-ROM, a flexible disk (FD), a CD-R, and a Digital Versatile Disc (DVD), in a file form in an installable format or an executable format. Further, the recording medium is not limited to the medium separate from the computer or the embedded system, and a recording medium which is recorded or temporarily recorded by program order downloading transmitted by a LAN or the Internet is also included.

In addition, the program to be executed in each device of the embodiment is configured to be stored on the computer connected to the network such as the Internet and to be provided by downloading through the network, or may be configured to be provided or distributed through the network such as the Internet.

What is claimed is:

1. An information processing device which allocates items to UI components included in an order receiving terminal,
the information processing device comprising:
a first display unit configured to display a list of the items on a display device;
a second display unit configured to display, on the display device, an allocation screen including component images corresponding to each UI component included in the order receiving terminal;
an allocation unit configured to allocate a selected item from the list to one of the component images designated as an allocation destination of the item;
a generation unit configured to generate allocation information including the selected item and the UI component corresponding to the component image to which the selected item is allocated; and
a provision unit configured to provide the allocation information generated by the generation unit to the order receiving terminal.

2. The information processing device according to claim 1, wherein the allocation screen indicates whether individual items have been allocated in the allocation unit.

3. The information processing device according to claim 1, wherein each of the items are one of a menu item corresponding to a product or service offered for purchase and a function item corresponding to a predetermined function.

4. The information processing device according to claim 3, wherein the first display unit is configured to display a menu item list of the menu items and to display a function item list of the function items, the first display unit being configured to switch between the menu item list and the function item list.

5. The information processing device according to claim 1, wherein each of the component images in the allocation screen is an image of a software button or a hardware key used as a UI in the order receiving terminal.

6. The information processing device according to claim 1, wherein the provision unit provides the allocation information to the order receiving terminal each time new allocation information is generated in the generation unit.

7. The information processing device according to claim 1, wherein each of the component images in the allocation screen is an image of a software button used as a UI in the order receiving terminal, and the allocation information includes a selected size of the software button.

8. A non-transitory computer-readable medium storing a computer program which causes a computer to:
display a list of the items on a display device;
display, on the display device, an allocation screen including component images corresponding to each UI component included in an order receiving terminal;
allocate a selected item from the list to one of the component images designated as an allocation destination of the item;
generate allocation information including the selected item and the UI component corresponding to the component image to which the selected item is allocated; and
provide the generated allocation information to the order receiving terminal.

9. The non-transitory computer-readable medium according to claim 8, wherein the allocation screen indicates whether individual items have been allocated in the allocation unit.

10. The non-transitory computer-readable medium according to claim 8, wherein each of the items are one of a menu item corresponding to a product or service offered for purchase and a function item corresponding to a predetermined function.

11. The non-transitory computer-readable medium according to claim 10, wherein the computer program further causes the computer to display a menu item list of the menu items and to display a function item list of the function items, and to switch between the menu item list and the function item list.

12. The non-transitory computer-readable medium according to claim 8, wherein each of the component images in the allocation screen is an image of a software button or a hardware key used as a UI in the order receiving terminal.

13. The non-transitory computer-readable medium according to claim 8, wherein the allocation information is provided to the order receiving terminal each time new allocation information is generated in the generation unit.

14. The non-transitory computer-readable medium according to claim 8, wherein each of the component images in the allocation screen is an image of a software button used as a UI in the order receiving terminal, and the allocation information includes a selected size of the software button.

15. A method of allocating items to UI components included in an order receiving terminal, the method comprising:
displaying a list of the items on a display device;
displaying, on the display device, an allocation screen including component images corresponding to each UI component included in the order receiving terminal;
allocating a selected item from the list to one of the component images designated as an allocation destination of the item;
generating allocation information including the selected item and the UI component corresponding to the component image to which the selected item is allocated; and
providing the allocation information generated by the generation unit to the order receiving terminal.

16. The method according to claim 15, wherein the list and the allocation screen are displayed simultaneously.

17. The method according to claim 15, further comprising indicating on the list whether individual items have been allocated to one of the component images.

18. The method according to claim 15, wherein each of the component images in the allocation screen is an image of a software button or a hardware key used as a UI in the order receiving terminal.

19. The method according to claim 15, wherein providing the allocation information to the order receiving terminal is performed each time new allocation information is generated.

20. The method according to claim 15, wherein each of the component images in the allocation screen is an image of a software button used as a UI in the order receiving terminal, the method further comprising:
accepting an input selecting a size of the software button, the selected size being included in the generated allocation information.
